(19) United States
(12) Patent Application Publication
(10) Pub. No.: US 2002/0151216 A1
(43) Pub. Date: Oct. 17, 2002

(54) Fastening structure for connector

(76) Inventor: Ti-Li Wei, Pan Chiao City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/835,513

(22) Filed: Apr. 17, 2001

(51) Int. Cl. H01R 13/648

(52) U.S. Cl. 439/607

(57) ABSTRACT

A fastening structure for connector and particularly a connector to externally mount on a device includes an insulation member having a plurality of conductive terminals located thereon and a metallic casing covering the insulation member from outside. The casing has two wings plates extended outwards from two lateral sides. Each wing plate is extended to form at least one contact terminal which may serve as a soldering leg for boning to the circuit board of the device, thereby to equip the connector with enhanced capability to withstand external forces of pulling, inserting, rocking or twisting without breaking away from the circuit board or affecting transmission quality.

### BACKGROUND OF THE INVENTION

(1) Field of the Invention

The invention relates to a fastening structure for connector and particularly a connector fastening structure that adapts to Universal Serial Bus (USB) specification for enhancing structural strength of engagement between the connector and circuit board to increase withstanding capability against external force from various directions.

(2) Description of the Prior Art

Connector adapted to USB specification is a connection port widely used in computer peripheral devices for telecommunication transmission. It integrates the transmission channel of the peripheral devices such as keyboard, mouse, modem and the like, and resolves the interface inconsistent problem that happens to traditional connection ports. Hence USB becomes a standard specification for most peripheral devices nowadays.

In order to overcome the portability problem, slim size and light weight have become a widely pursued design trend and goal in recent years among the producers of computer peripheral devices. For instance, the TERK Thumb Drive distributed by ARMAS of Taiwan is one of the typical products adapted such a concept. It has a small size but a big memory capacity. When in use, it can be directly fastened to the USB connector and inserted to the device and link to a computer to perform data copy, transmission and execution processes. It is very convenient to use.

Conventional male type connectors fastened to the devices generally use SMT soldering technique to bond contact terminals to the circuit board. As shown in FIG. 1, the bonding between the connector and circuit board is done solely by the contact terminals. When in use, the connector often subjects to pulling and insertion numerous times. The external forces exerting on the connector may come from various directions in the form of pulling and stretching, inserting and squeezing, rocking, twisting, or the like. It could result in breakdown or rupture of the contact terminals that have been soldered to the circuit board, and cause poor contact or short circuit, and seriously affect signal transmission quality and stability. There are still rooms for improvement regard enhancing bonding strength between the connector and circuit board.

### SUMMARY OF THE PRESENT INVENTION

In view of aforesaid disadvantages, it is therefore an object of the present invention to provide an improved connector structure that has enhanced bonding strength between the connector and circuit board to enable the connector to withstand pulling and insertion for a prolonged period of time without breaking away from the circuit board.

The connector according to the present invention has a novel fastening structure to provide increased bonding strength between the connector and circuit board. The connector is covered by a metallic casing from outside. The casing has two sides extended longitudinally outwards to form respectively a wing plate. The wing plate further extends in a selected direction to form one or more soldering leg whereby to bond with a circuit board with increased capability for withstand pulling and insertion force.

### BRIEF DESCRIPTION OF THE DRAWINGS

The present invention, as well as its many advantages, may be further understood by the following detailed description and drawings, in which:

FIG. 1 is a perspective view of a conventional connector;

FIG. 2 is a perspective view of a first embodiment of the present invention;

FIG. 3 is a sectional view of the first embodiment, showing the fastening structure between the connector and circuit board;

FIG. 4 is a perspective view of a second embodiment of the present invention;

FIG. 5 is a sectional view of the second embodiment, showing the fastening structure between the connector and circuit board;

FIG. 6 is a perspective view of a third embodiment of the present invention; and

FIG. 7 is a sectional view of the third embodiment, showing fastening structure between the connector and circuit board.

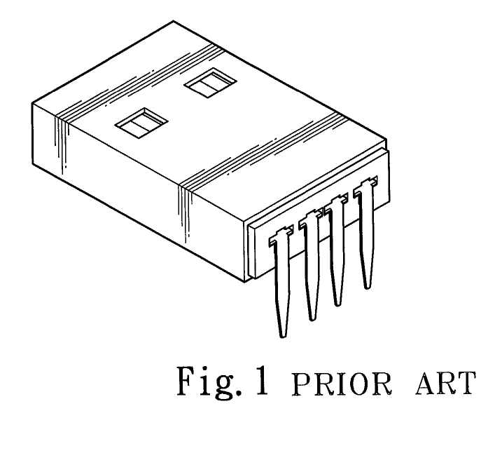

### DETAILED DESCRIPTION OF THE PREFERRED EMBODIMENTS

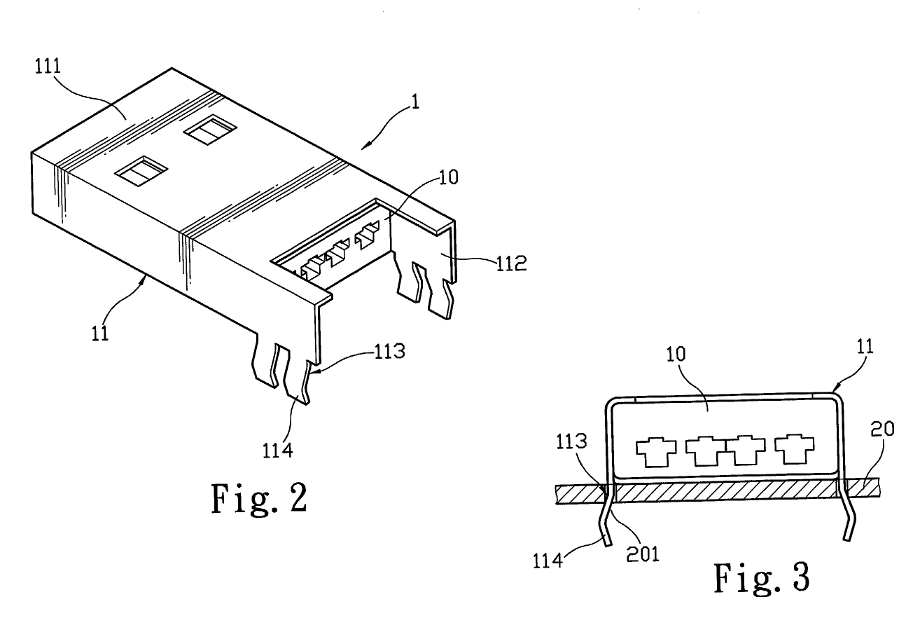

Referring to FIGS. 2 and 3 for an embodiment of the present invention, the connector 1 includes an insulation member 10 which has a plurality of conductive terminals and a metallic casing 11 covering the body 10 from outside. The casing 11 has a body 111 and two wing plates 112 extended outwards from two lateral sides of the body 111. Each wing plate 112 extends downwards to form at least one elastic contact leg 113.

When the connector 1 is used to engage with a computer peripheral device in an external insertion manner, the contact legs 113 may be inserted into slots 201 formed in the circuit board 20 of the device, then solder the contact legs 113 on the circuit board 20 to form a plurality of bonding spots. The bonding thus formed has greater strength and may better withstand interaction forces such as pulling, squeezing, rocking and twisting.

Moreover, one end of the contact leg 113 may be deformed in a curved shape facing inwards and to form a slant wedge section 114. When the contact leg 113 is inserted into the slot 201, the wedge section 114 may engage with the slot 201 securely thereby the contact leg 113 will be prevented from breaking away from the circuit board 20 without exerting to an external force when to solder the contact leg 113 to the circuit board 20.

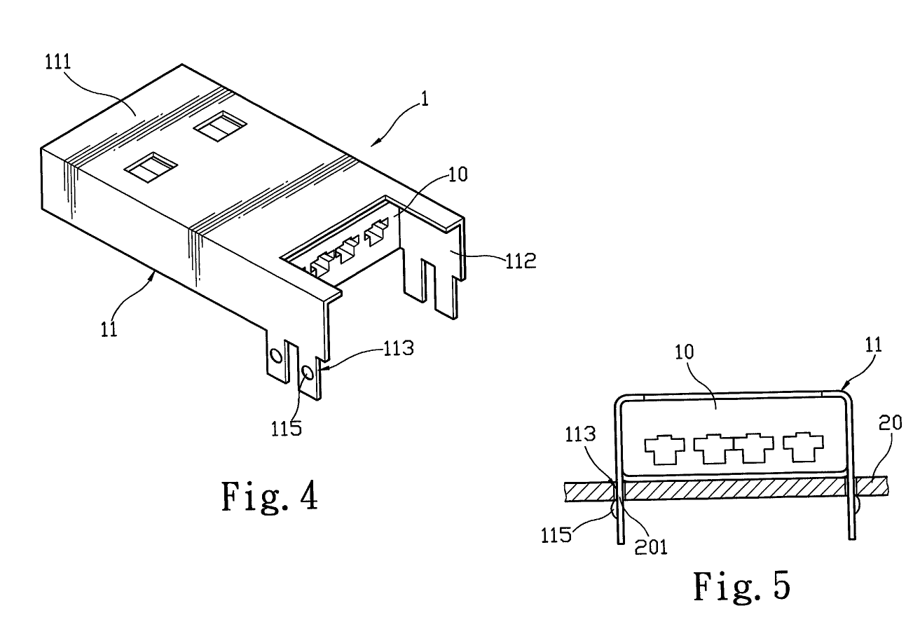

Referring to FIGS. 4 and 5 for another embodiment of the present invention, it mainly enables the contact leg 113 to insert and be held securely in the slot 201 of the circuit board 20 to facilitate soldering operation. The contact leg 113 is a flat strip and has a bulged spot 115 formed at one side thereof. When the contact leg 113 is inserted in the slot 201, the elastic strain of the contact leg 113 enables the bulged spot 115 held at another side of the slot 201 to engage with a lower side of the slot 201 securely.

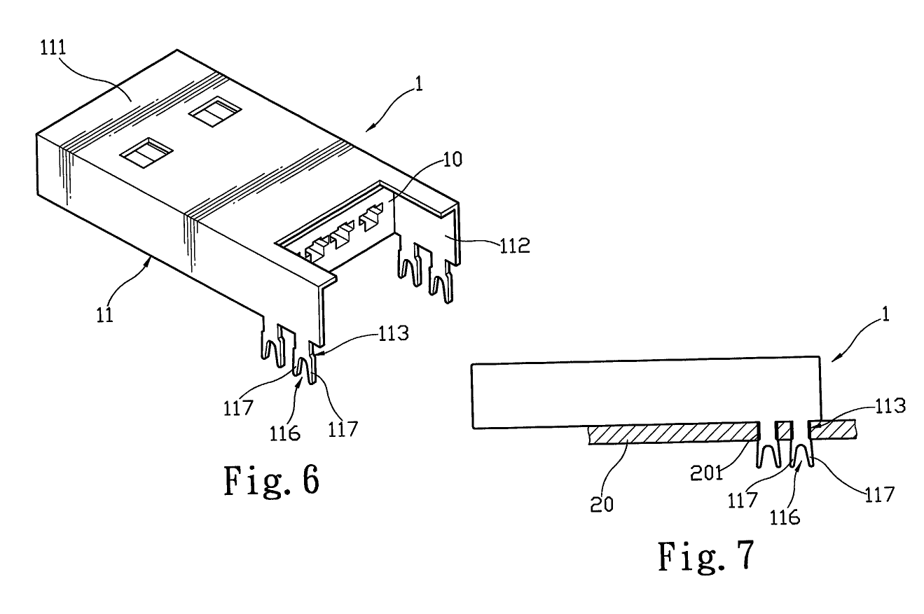

Referring to FIGS. 6 and 7 for yet another embodiment of the present invention, the lower end of the contact leg 113 is formed in a snap insert which has a notch 116 at the lower section and two snap legs 117 at two sides of the notch 116. When the contact leg 113 is inserted in the slot 201, the snap legs 117 is pressed against the slot 201 and contracted to pass through the slot 201 thereby to engage with the slot 201 securely.

The constructions of the present invention set forth above can effectively resolves the weak bonding problem encountered in the conventional connector when fastening to the circuit board of the devices, and provides more bonding locations between the connector and circuit board to better withstand external forces.

While the preferred embodiments of the present invention have been set forth for purpose of disclosure, modifications of the disclosed embodiments of the present invention as well as other embodiments thereof may occur to those skilled in the art. Accordingly, the appended claims are intended to cover all embodiments which do not depart from the spirit and scope of the present invention.

What is claimed is:

1. A fastening structure for connector to externally connect a device, comprising:
an insulation member having a plurality of conductive terminals disposed thereon and a metallic casing covering the insulation member from outside, the casing having two wing plates extended outwards from two lateral sides thereof, each wing plate being extended to form at least one soldering contact leg for mounting on the device to enhance withstanding capability of pulling and inserting resulting from external forces applied on the connector.

2. The fastening structure for connector of claim 1, wherein the contact leg has one end deformed in a curved shape towards inside to form a slant wedge section.

3. The fastening structure for connector of claim 1, wherein the contact leg has a bulged spot located at a lateral side thereof.

4. The fastening structure for connector of claim 1, wherein the contact leg has a notch formed at a lower section thereof and two snap legs located at two sides of the notch.
